(19) United States
(12) Patent Application Publication
(10) Pub. No.: US 2002/0017578 A1
(43) Pub. Date: Feb. 14, 2002

(54) Container with floating objects

(76) Inventor: Graham John Britton, London (GB)

Correspondence Address: Iandiorio & Teska, 260 Bear Hill Road, Waltham, MA, 02451-1018, US

(21) Appl. No.: 09/782,473

(22) Filed: Feb. 13, 2001

(30) Foreign Application Priority Data
Feb. 16, 2000 (GB) 0003938.8

(51) Int. Cl. A47J 42/38

(52) U.S. Cl. 241/169.1; 222/78

(57) ABSTRACT

A container (2) comprising a body portion (4) and a closure (6) for the body portion (4), the closure (6) comprising a chamber (8), at least one liquid (10) in the chamber (10), at least one object (12) floating in the liquid (10), and a bore (14) which extends through the closure (6).

This invention relates to a container and, more especially, this invention relates to a container having at least one floating object which may be used for decorative or promotional purposes.

Containers having at least one floating object are known. The known containers are usually such that they are manufactured for one specific purpose only, and they cannot easily be modified in order to enable the containers to be used for other purposes.

It is an aim of the present invention to reduce the above mentioned problem.

Accordingly, in one non-limiting embodiment of the present invention there is provided a container comprising a body portion and a closure for the body portion, the closure comprising a chamber, at least one liquid in the chamber, at least one object floating in the liquid, and a bore which extends through the closure.

By placing the floating object in the closure and by having a bore which extends through the closure, the container of the present invention can easily be modified to be suitable for a wide variety of different uses.

Preferably, the bore is centrally positioned in the closure. The bore may however be off-centre if desired.

Preferably the chamber surrounds the bore. The floating object is then generally able to be visible from all sides. If desired, the chamber may be such that it is provided on one side only of the bore, or only partially surrounds the bore.

In a first embodiment of the invention, the container includes an obturator for blocking the bore. In this case, the container may be used as a storage pot, for example for receiving any suitable and appropriate objects such for example as tooth picks, ear cotton buds, or herbs.

In the first embodiment of the invention, the closure is preferably a push fit on the body portion. The closure may however be connected to the body portion by any other suitable and appropriate means, for example by a screw threaded arrangement.

In a second embodiment of the invention, the container includes a dispenser device for dispensing a product contained in the body portion and passing along the bore.

Any suitable and appropriate product may be dispensed such for example as salt, pepper or talcum powder.

In the second embodiment of the invention, the container preferably includes securing means for releaseably securing the closure to the body portion. The releaseable securing means is preferably a screw threaded arrangement but other types of securing means such for example as a bayonet arrangement may be employed if desired. Generally, the securing means should be such that the salt, pepper or other product in the body portion can be dispensed through the dispenser device without the closure falling off the body portion.

In a third embodiment of the invention, the container includes a spoon, the spoon having a handle which is rotated in the bore.

The spoon can be used to dispense a product contained in the body portion. Any suitable and appropriate product may be contained in the body portion, for example a food product such as mustard.

In the third embodiment of the invention, the closure is preferably a push fit on the body portion. The closure may be another type of fit, for example a screw threaded fit, if desired.

In a fourth embodiment of the invention, the container includes grinder means, the grinder means having a shaft which is located in the bore.

The shaft may have a handle which extends out of the bore and which is for turning the grinder means. The shaft will then rotate in the bore. Alternatively, if desired, the shaft may be fixed in the bore so that rotation of the closure causes the turning of the grinder means.

In the fourth embodiment of the invention, the container may include securing means for releaseably securing the closure to the body portion. The securing means is preferably a screw threaded securing means but other securing means such for example as a bayonet type securing means may be employed.

In all embodiments of the invention, the closure is preferably a round closure. Other shapes may however be employed so that, for example the closure may be square, rectangular or eliptical.

Preferably, the closure is transparent. Also preferably, the body portion is transparent. The container is preferably made of a transparent acrylic material. Other materials may however be employed.

The container may be such that there is only one of the liquids. In this case an air gap will usually be present in the closure. Alternatively, there may be two of the liquids, the liquids being immiscible with each other. In this case, there will usually be no air gap in the closure. Any suitable and appropriate liquids may be employed. The object will usually be such that it floats on top of the liquid when there is only one liquid, or on top of the lowermost liquid when there are two of the liquids. If desired however, the object may be arranged to float in a submerged condition.

Any suitable and appropriate floating object may be employed. Thus, for example, the floating object may be an animal such for example as a duck, penguin or fish. The object may be a fruit such for example as an apple or banana. The object may be a miniature drink bottle, for example used when the container is to be for promotional use.

Embodiments of the invention will now be described solely by way of example and with reference to the accompanying drawings in which:

FIG. 1 shows a first container for use as a storage pot;

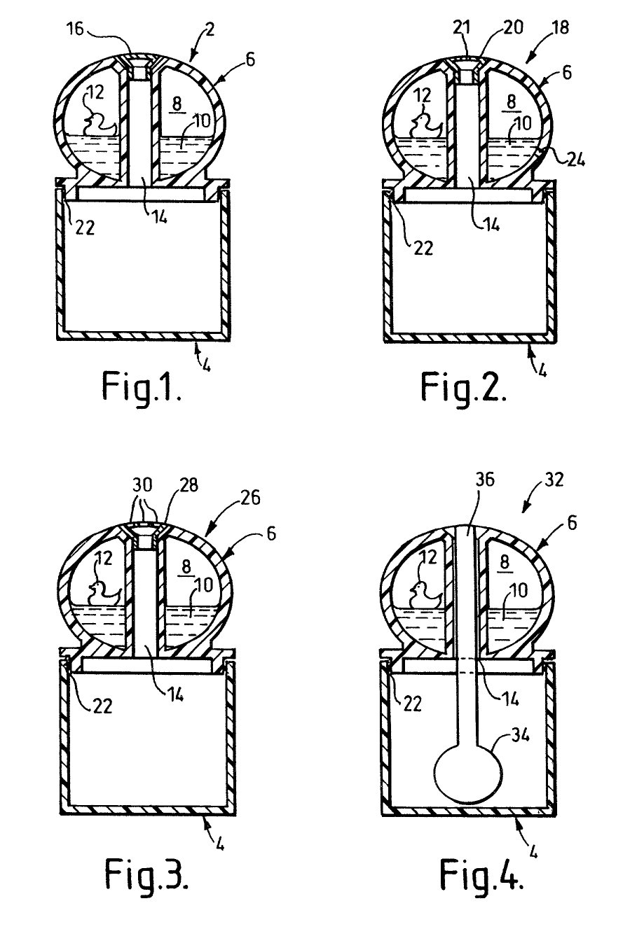

FIG. 2 shows a second container for use as a salt pot;

FIG. 3 shows a third container for use as a pepper pot;

FIG. 4 shows a fourth container for use as a mustard pot;

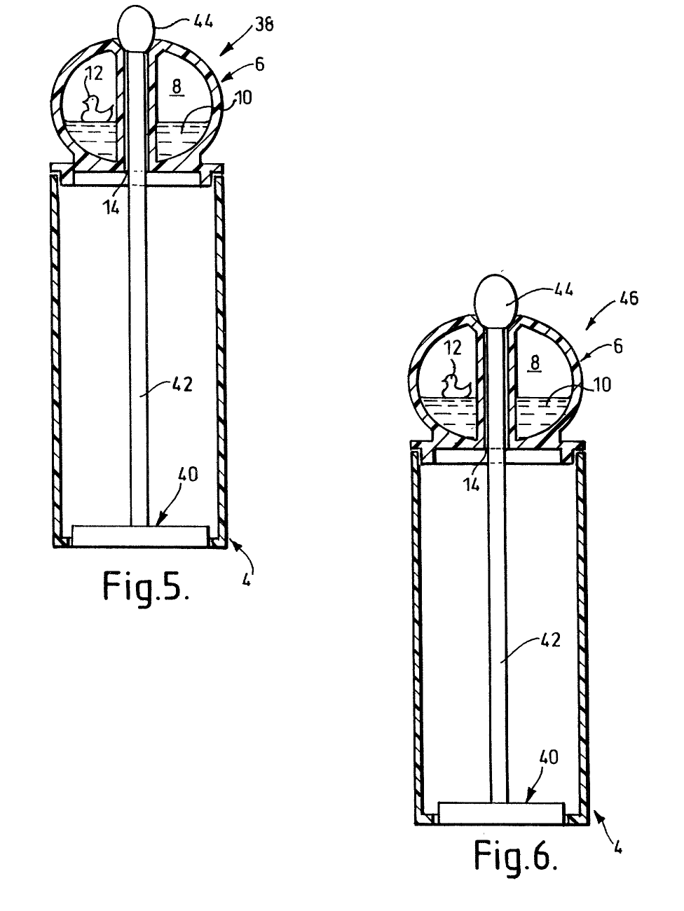

FIG. 5 shows a fifth container for use as a pepper grinder;

FIG. 6 shows a sixth container for use as a salt grinder;

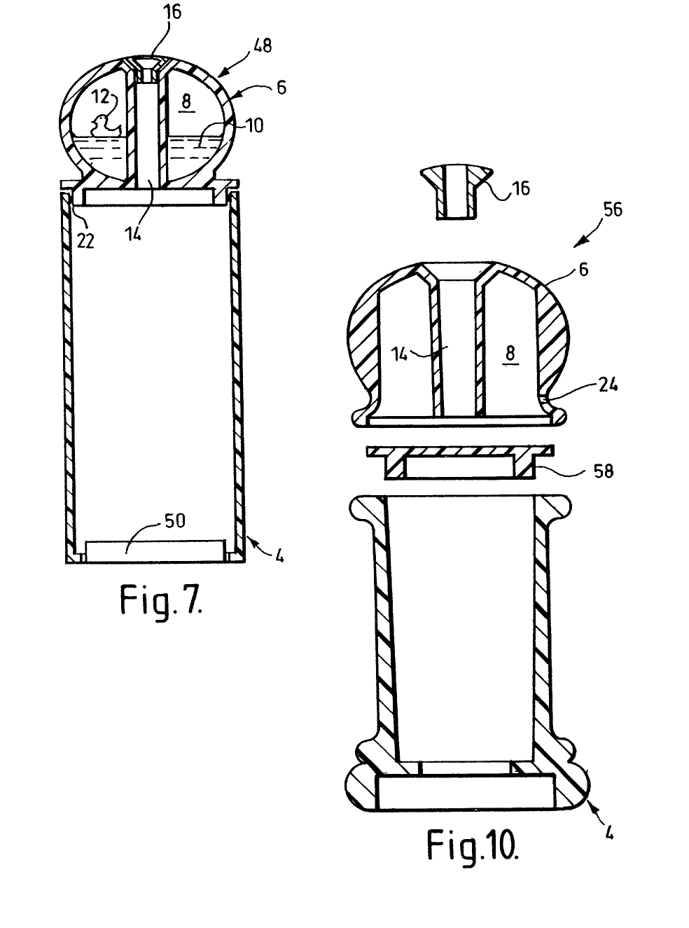

FIG. 7 shows a seventh container for use as a storage pot;

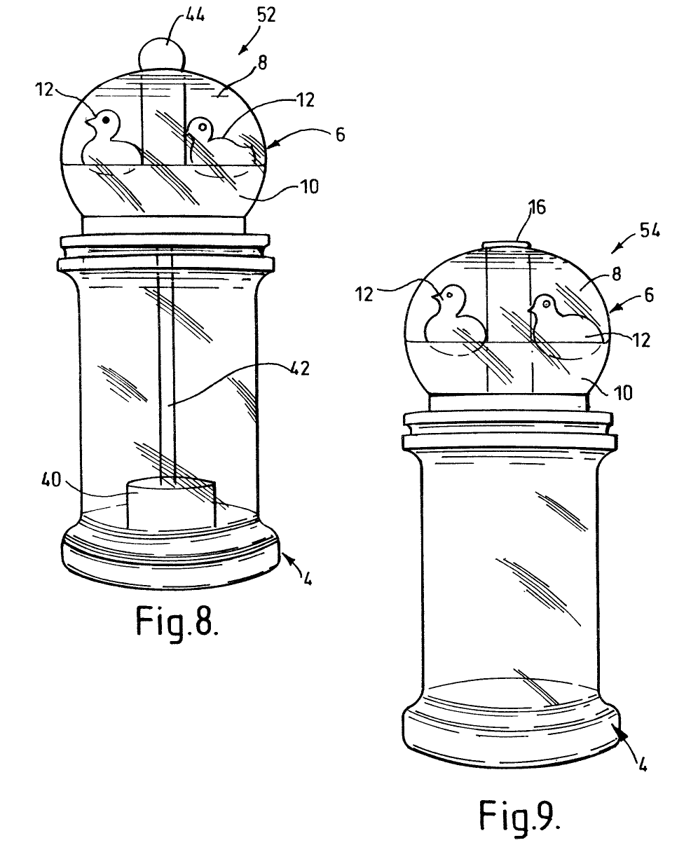

FIG. 8 shows an eighth container for use as a grinder;

FIG. 9 shows a ninth container for use as a storage pot; and

FIG. 10 illustrates how the containers are constructed.

Referring to FIG. 1, there is shown a container 2 comprising a body portion 4, and a closure 6 for the body portion 4. The closure 6 comprises a chamber 8, a liquid 10 in the chamber 8, and an object 12 floating in the liquid 10. A bore 14 extends through the closure 6 as shown. The bore 14 is centrally positioned in the closure 6. The chamber 8 surrounds the bore 14.

The container 2 includes an obturator 16 which pushes into the bore 14 as shown and thus blocks the bore 14. The closure 6 is thus completely closed. The closure 6 is able to close completely the body portion 4. The body portion 4 may be for containing any suitable and appropriate types of products such for example as tooth picks, ear cotton buds, and herbs.

Referring now to the remaining drawings, similar parts have been given the same reference numerals for ease of comparison and understanding.

In FIG. 2, there is shown a container 18 which is similar to the container 2 except that the body portion 4 is for receiving salt. In order to enable the salt to be dispensed, the obturator 16 in FIG. 1 has been replaced by a dispenser device 20 for dispensing the salt. The dispenser device 20 is provided with an aperture 21 through which the salt passes.

The container 18 includes securing means 22 for securing the closure 6 on the body portion 4. This is in order to ensure that the closure 6 does not fall off the body portion 4 when the container 2 is inverted for the purpose of dispensing the salt through the aperture 21. The securing means 22 will usually be a screw threaded securing means but other types of securing means 22 may be employed.

Also shown in FIG. 2 is a passage 24 which enables the liquid 10 to be introduced into the chamber 8. After the introduction of the liquid 10, the passage 24 is sealed.

FIG. 3 shows a container 26 in which the body portion 4 is for containing pepper instead of salt. The pepper is dispensed through a dispenser device 28 having a plurality of apertures 30.

FIG. 4 shows a container 32 which includes a spoon 34. The spoon 34 has a handle 36 which is located in the bore 14 as shown. The closure 6 is a simple push fit on the body portion 4 so that the closure 6 can easily be removed from the body portion 4. The spoon 34 can then be used for dispensing a product contained in the body portion 4. The product may be a food product such for example as mustard, or a cosmetic product such for example as a cream.

FIG. 5 shows a container 38 which includes grinder means 40. The grinder means 40 has a shaft 42 which is located in the bore 14 as shown. The shaft 42 has a handle 44 which extends out of the bore 14 and which is for turning the grinder means 40. As the grinder means 40 is turned, the shaft 40 rotates in the bore 14. The container 38 shown in FIG. 5 is for dispensing pepper so that the container 38 is a pepper grinder.

FIG. 6 shows a container 46 which is basically the same as the container 38 but which is for grinding salt so that the container 46 is a salt grinder.

FIG. 7 shows a container 48 which is like the containers 38, 46 except that the shaft 42 of the grinder means has been omitted. A grinder part 50 of the grinder means 40 has been retained so that the body portion 4 basically becomes a closed container. The bore 14 is closed by an obturator 16 of the type shown in FIG. 1. The container 48 thus becomes a storage pot like the container 2, but having a longer body portion 4.

FIG. 8 shows a container 52 which is similar to the containers 38 and 46. In FIG. 8, the body portion 4 is slightly differently shaped to the body portion 4 in the containers 38 and 46. FIG. 9 shows a container 54 which is like the container 48 shown in FIG. 7 but with a body 4 like that shown in FIG. 8.

FIG. 10 shows a container 56 and illustrates how the closure 6 has a bottom part 58 which is separate from the remainder of the closure 6 for the purpose of filling the chamber 8 with the liquid 10 and one or more of the objects 12. The bottom part 58 is then sealed in position, the sealing preferable being sonic sealing.

All of the containers shown in the drawings are made of a transparent acrylic plastics material. The contents of the body portion 4 and also the contents of the closure 6 can thus always easily be seen.

It is to be appreciated that the embodiments of the invention described above with reference to the accompanying drawings have been given by way of example only and that modifications may be effected. Thus, for example, the object 12 is shown in the form of a duck. Any suitable and appropriate other types of objects may be employed including fruit and miniature beverage bottles. One or more of the objects 12 may be contained within the chamber 8. The chamber 8 may have only one liquid 10 in it, in which case the space above the liquid will usually be air. Alternatively, the chamber 8 may contain two immiscible liquids. Materials other than the transparent acrylic material may be used for producing the containers of the present invention so that, for example, the containers may be produced in glass.

1. A container comprising a body portion and a closure for the body portion, the closure comprising a chamber, at least one liquid in the chamber, at least one object floating in the liquid, and a bore which extends through the closure.

2. A container according to claim 1 in which the bore is centrally positioned in the closure.

3. A container according to claim 1 in which the chamber surrounds the bore.

4. A container according to claim 1 and including an obturator for blocking the bore.

5. A container according to claim 4 in which the closure is a push fit on the body portion.

6. A container according to claim 1 and including a dispenser device for dispensing a product contained in the body portion and passing along the bore.

7. A container according to claim 6 and including securing means for releaseably securing the closure to the body portion.

8. A container according to claim 1 and including a spoon, the spoon having a handle which is located in the bore.

9. A container according to claim 1 and including grinder means, the grinder means having a shaft which is located in the bore.

10. A container according to claim 9 and including securing means for releaseably securing the closure to the body portion.

11. A container according to claim 1 in which the closure is transparent, and in which the body portion is transparent.

12. A container according to claim 1 in which there is only one of the liquids.

13. A container according to claim 1 in which there are two of the liquids, the liquids being immiscible with each other.
